(19) United States
(12) Patent Application Publication
(10) Pub. No.: US 2020/0086318 A1
(43) Pub. Date: Mar. 19, 2020

(54) SYSTEM AND METHOD FOR CREATING QUANTIFIABLE SIGNALS

(71) Applicant: SANDHILL CRANE DIAGNOSTICS, INC., San Diego, CA (US)

(72) Inventors: Metin BILGIN, San Diego, CA (US); Sylvia A. NORMAN, Poway, CA (US)

(21) Appl. No.: 16/370,532

(22) Filed: Mar. 29, 2019

Related U.S. Application Data
(60) Provisional application No. 62/650,700, filed on Mar. 30, 2018.

(51) Int. Cl. B01L 3/00

(52) U.S. Cl. CPC B01L 3/502738; B01L 3/50273; B01L 2200/0647; B01L 2400/0487; B01L 2400/0415; B01L 2300/0816

(57) ABSTRACT

Disclosed herein is a system that relies upon an assay card employing only capillary action and no outside energy source containing cargo-loaded gated porous nanoparticles, an optional device cartridge, an optional reagent container, and optional software for detection and/or quantitation of at least one target analyte of a liquid sample.

### FIELD OF THE INVENTION

The present invention relates to a system and a method for assaying a sample of a solution for particular components or analytes and the creation of quantifiable signals identifying the targeted components or analytes. The resulting signals identify the presence or absence of the targeted component or analyte or show the level of expression and can possibly be used for diagnosis. Furthermore, removal of the components or analytes allows purification of the remaining solution.

### BACKGROUND

An inexpensive, robust, and rapid self-contained system for detecting the presence and/or absence of solution components or analytes is particularly needed for testing at rural, disaster, or mobile locations. Such locations typically lack facilities that permit standard, but time-consuming, testing such as culturing samples to identify the presence of life forms (e.g. bacteria, viruses, protozoa, etc.) and the use of GC-MS, PCR, ELISA, etc. to identify particular molecules or analytes in a sample.

While identification and/or separation of solution components can also be achieved using microfluidic approaches, these typically require application of energy. For example, identification and/or separation of solution components is characteristically conducted via electrophoresis or the use of electric fields (e.g. U.S. Pat. Nos. 6,613,525, 7,041,208, and 9,594,051), application of vacuum (e.g. US 2012/149,007), or the use of pumps (e.g. U.S. Pat. No. 9,234,884 and US 2017/080,420). Analysis of samples in many rural, remote, disaster and/or mobile locations is difficult because of the lack of access to energy sources that provide electricity. Consequently, samples must be physically removed adding time before analysis can be conducted and placing the integrity of the sample at risk.

Consequently, the ability to obtain a sample from the environment or an individual and to then analyze the presence or concentration of one or more target analytes rapidly and at low cost is particularly desirable. The system and method disclosed herein address this need.

### SUMMARY OF THE INVENTION

It is an object of the present invention to provide an improved single-use, stand alone, portable assay system for identification and quantitation of solution components without application of any external energy source.

Accordingly, there is provided a system for creating quantifiable signals comprising a one-time-use assay card, an optional device cartridge, and an optional reagent container. Application of a solution sample to the sample input chamber transports the sample via microfluidic channels without application of external energy to the reaction and/or detection chamber. Binding of a target to the target detector molecule in the detection chamber releases the at least one reporter molecule. The released and concentrated reporter molecules are then detected and quantified by capturing an image of them with a cell phone camera, saving the image, and using software such as that described in GB1721811.6 and/or U.S. Pat. No. 9,903,857. having at least one specific target detector molecule and at least one reporter molecule. Application of a solution sample to the sample input chamber transports the sample via microfluidic channels without application of external energy to the detection chamber. Binding of a target to the target detector molecule in the detection chamber releases the at least one reporter molecule, which is then accumulated in the detection chamber, in some embodiments on an optional signal concentration pad. The released and concentrated reporter molecules are then detected and quantified.

Another embodiment provides a one-time-use assay card with a sample input chamber or area in fluid communication with at least two microfluidic channels, each leading to a reaction chamber containing nanoparticles having at least one specific target detector molecule and at least one reporter molecule. Application of a solution sample to the sample input chamber transports the sample via microfluidic channels without application of external energy to a reaction chamber. Binding of a target to the target detector molecule in the reaction chamber releases the at least one reporter molecule, which is then transported via microfluidic channels without application of external energy to a detection chamber. The detection chamber contains nanoparticles having at least one specific target detector molecule and at least one reporter molecule, each of which may be identical to those associated with the nanoparticles in the reaction chamber or may be different. Further binding of a target to a target detector molecule in the detection chamber releases at least one reporter molecule, which is then accumulated in the detection chamber, in some embodiments on an optional signal concentration pad. The released and concentrated reporter molecules from the reaction chamber and the detection chamber are then detected and quantified.

Yet another embodiment provides a one-time-use assay card with a sample input chamber or area in fluid communication with at least two microfluidic channels, each leading to a reaction chamber containing nanoparticles having at least one specific target detector molecule and at least one reporter molecule. Application of a solution sample to the sample input chamber transports the sample via microfluidic channels without application of external energy to a reaction chamber. Binding of a target to the target detector molecule in the reaction chamber releases the at least one reporter molecule, which is then transported via microfluidic channels without application of external energy to a signal chamber. The released and concentrated reporter molecules are then detected and quantified.

In some embodiments, the sample input chamber, microfluidic channels, detection, reaction, and/or signal chambers are attached to a flat surface. In other embodiments the sample input chamber, microfluidic channels, detection, reaction, and/or signal chambers are attached to a curved surface. The sample input chamber, microfluidic channels, detection, reaction, and signal chambers are made of polymers. In some embodiments the sample input chamber, microfluidic channels, detection, reaction, and/or signal chambers are made from polystyrene (PS), polyether ether ketone (PEEK), polytetrafluoroethylene (PTFE), or fluorinated ethylene propylene (FEP). In other embodiments the sample input chamber, microfluidic channels, detection, reaction, and/or signal chambers are made from polyethylene terephthalate (PET). The polymers making up the sample input chamber, microfluidic channels, detection, reaction, and/or signal chambers provide a non-porous environment. In some embodiments the polymers are innately hydrophobic and/or non-porous while in others the polymer is coated with an agent to achieve non-porosity.

In some embodiments the nanoparticles are made of metal, metalloids, organometallics, clay, polymers, hydrogels, and/or combinations thereof. In other embodiments the nanoparticles are silica and/or mesoporous silica nanoparticles. In still other embodiments the nanoparticles are porous nanoparticles. Some embodiments use surface modified nanoparticles, for example, but without limitation, polycations, lipids, or NH₂. Some embodiments contain gated nanoparticles, such as nanoparticles gated with protein, DNA, aptamers, haptens, peptides and/or antibodies that detect and bind to the target. In embodiments using gated nanoparticles, removal and/or movement and/or reconfiguration of the gating molecule releases a cargo molecule. In some embodiments the cargo molecule is a dye, such as but without limitation methylene blue, Safranin-O, vinyl sulfones, neutral red, eriochrome black T, and/or combinations thereof. In other embodiments the cargo molecule is a fluorescent molecule, such as fluorescein, rhodamine B and/or green fluorescent protein (GFP).

Another embodiment of the invention provides an optional device cartridge that houses the assay card of the system for creating quantifiable signals. The optional device cartridge has a housing that defines an interior chamber with at least one sample input port, at least one detection window, and, optionally, a reagent container port, each in connection with the interior chamber. The interior chamber of the optional device cartridge is configured to hold the assay card. The housing is configured so that the at least one sample input port of the housing will be in fluid communication with the sample input chamber of the assay card upon addition of sample. In addition, the housing is configured so that the detection window is aligned with the detection chamber and/or signal chamber of the assay card. Other embodiments also contain an outside opening to the internal chamber to allow placement and removal of an assay card into the interior chamber of the housing.

Yet another embodiment of the invention provides an optional device that is a reagent container. The optional reagent container device has a housing that defines an interior chamber with at least one outside opening. Reagent is stored within the interior chamber of the optional reagent container device. In some embodiments the reagent is stored in a container fitted within the interior chamber of the optional reagent container device. In other embodiments, the reagent is in direct contact with the walls of the interior chamber of the optional reagent container device. When the reagent is in direct contact with the walls of the interior chamber of the optional reagent container device, the reagent is maintained in place with a seal covering or internal to the at least one outside opening.

### BRIEF DESCRIPTION OF THE FIGURES

FIG. 1A depicts one embodiment of the assay card (1) for creating quantifiable signals, showing a sample input chamber or area (2) and an optional fluid reservoir (3) that is in fluid communication with each of three microchannels (4) leading to a combination reaction/signal detection chamber (5) having a detection window (6), and an optional signal concentration pad (7). FIG. 1B depicts another embodiment of the assay card (1) for creating quantifiable signals containing all of the elements shown in FIG. 1A with an additional reaction-only chamber (8) and additional microchannels (9). FIG. 1C depicts yet another embodiment of the assay card (1) for creating quantifiable signals showing a sample input chamber or area (2) and an optional fluid reservoir (3) that is in fluid communication with each of three microchannels (4) leading to a reaction-only chamber (8). The reaction-only chamber (8) is in fluid communication with microchannels (9) that lead to a signal chamber (10). The signal chamber is in fluid communication with microchannel (11). Microchannel (11) optionally terminates in a vent (12). FIG. 1D depicts another embodiment of the assay card (1) for creating quantifiable signals, showing a sample input chamber or area (2) and an optional fluid reservoir (3) that is in fluid communication with each of three microchannels (4) leading to a combination reaction/signal detection chamber (5) having a detection window (6), and an optional signal concentration pad (7) and a vent (12). FIG. 1E depicts still another embodiment of the assay card (1) for creating quantifiable signals containing all of the elements shown in FIG. 1B with a vent (12).

FIG. 2A shows one organization for the layers forming the assay card with the reaction chamber having a greater volume than the signal chamber. FIG. 2B shows the volume of the reactions chamber and signal chamber to be equal. FIG. 2C shows the reaction chamber having a smaller volume than the signal chamber.

FIG. 3A shows one embodiment of the optional reagent container (30) that has a reagent container housing (31) with an interior chamber (34), a reagent container outlet port (32), and an optional reagent container inlet port (33). The optional reagent container (30) can be fitted to the device cartridge (20) sample input port (23) with an optional separate connector (35). FIG. 3B shows another embodiment of the optional reagent container (30) that has a reagent container housing (31) with an interior chamber (34), a reagent container outlet port (32) and an optional reagent container inlet port (33). Here, the connector (35) is an integral part of the optional reagent container. FIG. 3C represents the optional device cartridge (20) coupled to the optional reagent container (30). FIG. 3D depicts another embodiment of the optional device cartridge (20) with a cut-away opening (25) at the distal end from the sample input port (23) allowing easy placement of an assay card (1) into the optional device cartridge (20). FIG. 3E is an end view of the distal end of the optional device cartridge (20) showing the arrangement of the housing (21), interior chamber (22), assay card (1) and cut-away opening (25).

FIG. 4 presents the results from experiments using anti-thyroid stimulating hormone (TSH) antibody gated nanoparticles. The top photo is the inverse of the lower photo, allowing easier identification of the results. “Ab−” represents nanoparticles with no anti-TSH antibody, “Ab+” represents nanoparticles with 2 μg/mg anti-TSH antibody, “Ab++” represents nanoparticles with 12 μg/mg anti-TSH antibody, “TSH-” represents reactions with no TSH antigen present, “TSH+” represents reactions with 20 mIU/lt TSH antigen present, and “TSH++” represents reactions with 100 mIU/lt TSH antigen present. Duplicate reactions were conducted for 60 minutes at 37° C., with one fifth (0.20 μl) of each reaction volume spotted on neutral nylon membrane.

FIG. 5 shows the results of reactions conducted at 37° C. for 70 minutes using 0.2 mg of SBA-15 anti-TSH antibody gated nanoparticles, 1 mg/ml methylene blue as the cargo molecule, and 40 mIU/lt TSH antigen as the analyte.

FIG. 6 shows the results of the experiments of FIGS. 4 and 5 conducted on an assay card. FIG. 6A: depicts the design of the assay card used (see FIG. 1A). FIG. 6B: shows an assay card before the application of sample reaction buffer containing the analyte (40 mIU/lt TSH antigen in PBS buffer) to the card. All three reaction/detection chambers of the assay card were loaded with 0.2 mg of nanoparticles carrying a methylene blue reporter dye as cargo and capped with anti-TSH antibodies (T-111A, Fitzgerald Industries). FIG. 6C: presents the results of the same assay card approximately 60 minutes after introduction of sample reaction buffer with analyte (40 mIU/lt TSH antigen) and incubation at 37° C. Dyes released from the nanoparticles accumulated on the signal concentration pads (nitrocellulose, WHATMAN® BA83, 4 mm in diameter) and created a visually detectable, qualitative chromogenic signal, indicating release of reporter in response to the analyte in the buffer.

FIG. 7 shows the results of experiments conducted on an assay card according to FIG. 1B. MCM-41 nanoparticles contained the reporter molecule Safranin-O with gating antibodies as follows: Ab1=anti TSH monoclonal mouse antibody, 10378 (Fitzgerald Laboratories), Ab2=anti-TSH monoclonal mouse antibody, T-111A10378 (Fitzgerald Laboratories), and C Ab=Myo7a (a nonspecific control antibody).

FIG. 8 shows the results of a TSH assay experiment conducted with fluorescein. Myo7=Myosin VIIa used as a background control; T111A (Fitzgerald Laboratories)=a first TSH antibody; 7386 (Fitzgerald Laboratories)=a second TSH antibody.

FIG. 9 shows T4 detection using an assay conducted with MCM-41 gated nanoparticles and Safranin-O.

### DETAILED DESCRIPTION

The practice of the present invention may employ techniques from molecular biology (including recombinant techniques), cell biology, immunoassay technology, microscopy, image analysis, and analytical chemistry, which are within the skill of the art. Such techniques include, but are not limited to, detection of visual or fluorescent signals, image analysis, selection of illumination sources and optical signal detection components, labeling of biological cells, preparation of nanoparticles and the like. Such techniques and descriptions can be found in standard laboratory manuals such as Genome Analysis: A Laboratory Manual Series (Vols. I-IV), Using Antibodies: A Laboratory Manual, Cells: A Laboratory Manual, PCR Primer: A Laboratory Manual, and Molecular Cloning: A Laboratory Manual (all from Cold Spring Harbor Laboratory Press); Murphy, Fundamentals of Light Microscopy and Electronic Imaging (Wiley-Liss, 2001); Shapiro, Practical Flow Cytometry, Fourth Edition (Wiley-Liss, 2003); Herman et al., Fluorescence Microscopy, 2nd Edition (Springer, 1998); the disclosures of which are herein incorporated in their entirety by reference for all purposes.

It is to be understood that this invention is not limited to particular embodiments described, as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are described below.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. Further, the dates of publication provided may be different from the actual publication dates which may need to be independently confirmed.

As used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only,” and the like in connection with the recitation of claim elements or use of a “negative” limitation.

### Definitions

“Aptamer” as used herein refers to a small single-stranded nucleic acid that folds into a well-defined three-dimensional structure, shows a high affinity and specificity for its target molecule such as, but not limited to, small molecules, peptides, proteins, cells, and tissues, and inhibits that biological function.

“Assaying” is used herein in its conventional sense to refer to qualitatively assessing or quantitatively measuring the presence or amount of a target analyte species.

“Biological solution” as used herein includes blood, mucus, lymphatic fluid, synovial fluid, cerebrospinal fluid, saliva, sweat, bronchoalveolar lavage, amniotic fluid, amniotic cord blood, urine, vaginal fluid, semen, and plant sap. Furthermore, “biological solution” also includes a homogenate, lysate or extract prepared from an organism or a subset of its tissues. For animals this includes, but is not limited to, for example, plasma, serum, spinal fluid, lymph fluid, sections of the skin, respiratory, gastrointestinal, cardiovascular, genitourinary tracts, tears, saliva, milk, blood cells, tumors, and organs. For plants this includes, but is not limited to, for example, leaves, stems, roots, rhizomes, flowers, fruit, trichomes, and seeds. “Biological solutions” may also include any type of organismic material, including both healthy and diseased components (e.g., cancerous, malignant, necrotic, etc.). In certain embodiments, the biological solution is a whole blood or a derivative thereof, plasma, tears, sweat, urine, semen, etc.

“Cargo molecule” as used herein refers to a molecule, typically a reporter molecule such as a chromogenic, fluorescent, and/or luminescent compound that is sequestered in the pores of a porous nanoparticle. Cargo molecules are sequestered in the pores by non-covalent chemical interactions and can also diffuse out when placed in aqueous media. This term is used interchangeably with the term “guest molecule” and “reporter molecule.”

“Chamber” as used herein means a discrete area which differs from the surrounding area in terms of its shape and/or chemical composition. The boundaries or walls of the chamber may have empty space within its boundaries/walls or may be associated with a different chemical composition compared to the surrounding area.

“Guest molecule” as used herein refers to a molecule, typically a reporter molecule, that is sequestered in the pores of a porous nanoparticle. This term is used interchangeably with the term “cargo molecule” and “reporter molecule.”

“Hapten” as used herein refers to a small molecule that, when combined with a larger carrier, such as a protein, can elicit the production of antibodies that bind specifically to it (in the free or combined state). “Hapten” can also be described as a molecule that mimics an analyte and binds to the target antibody with low affinity. This interaction is disrupted in the presence of a target analyte when present in the biological solution being tested.

“Mammal” or “mammalian” as used herein refers to organisms that are within the class mammalia, including the orders carnivore (e.g., dogs and cats), rodentia (e.g., mice, guinea pigs, and rats), and primates (e.g., humans, chimpanzees, and monkeys). In some instances, the mammals are humans. In other instances, the mammals are non-human mammals such as, but not limited to, mice, rats, dogs, cats, livestock, and horses.

“Molecular gate” as used herein is a molecule that performs a mechanical movement based on an external stimulus. “Molecular gate” is used interchangeably with the term “nanovalve.”

“Nanovalve” as used herein is a molecule that performs a mechanical movement based on an external stimulus. “Nanovalve” is used interchangeably with the term “molecular gate.”

“Reporter molecule” as used herein refers to a molecule, that is sequestered in the pores of a porous nanoparticle. This term is used interchangeably with the term “cargo molecule” and “guest molecule.”

“TBAOH” is the acronym that refers to the chemical compound Tetrabutylammonium hydroxide having the formula (C₄H₉)₄NOH, also abbreviated Bu₄NOH. TBAOH is used herein as a 1.0 M solution in 2-methoxyethanol.

“TsOH” is the acronym that refers to the chemical compound tosylic acid with the formula CH₃C₆H₄SO₃H and also known as p-Toluenesulfonic acid (PTSA or pTsOH). TsOH is used herein as a 1.0 M solution in 2-methoxyethanol.

### Assay System

A system for assaying a solution sample for particular analytes or components and methods for using the same are described. The system disclosed relies upon passage of a solution through self-contained microfluidic channels without application of any external energy source. The system comprises a one-time-use assay card, an optional housing for the assay card, an optional reagent container, and software such as that of GB1721811.6 and/or U.S. Pat. No. 9,903,857 for quantifying signal produced on the assay card.

In some embodiments, the assay card, optional device cartridge, and optional reagent container are sterilized, either separately or in combination. Sterilization can be affected by autoclaving, irradiation (e.g. X-Ray radiation, electron beam radiation, ionizing radiation (such as, but not limited to, gamma irradiation), etc.) and/or ethylene oxide treatment.

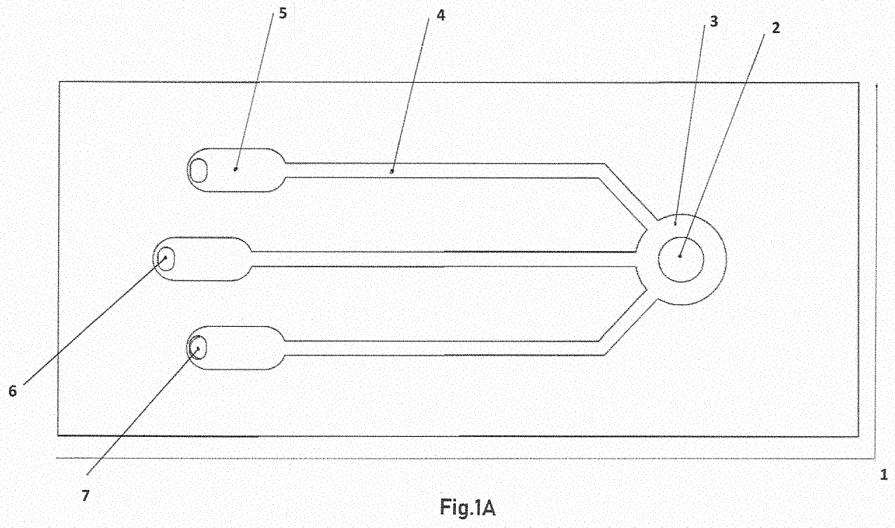

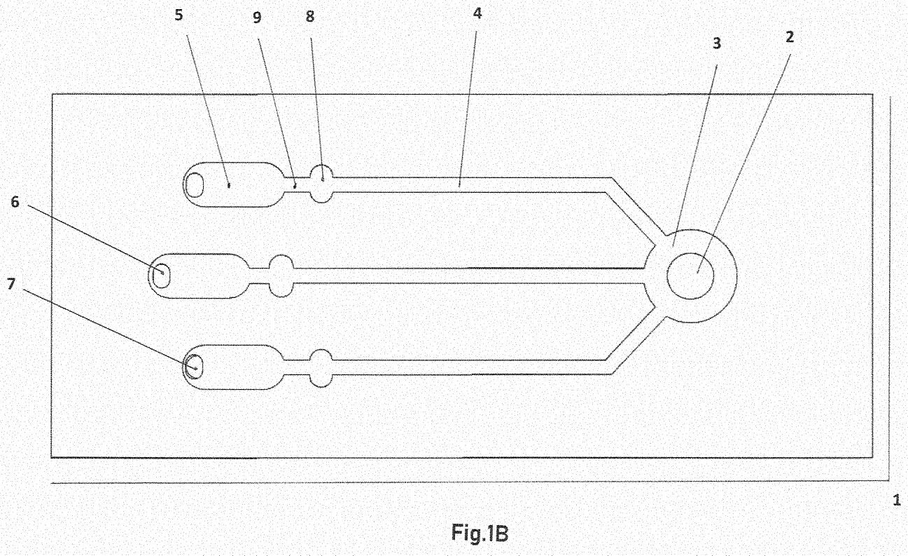

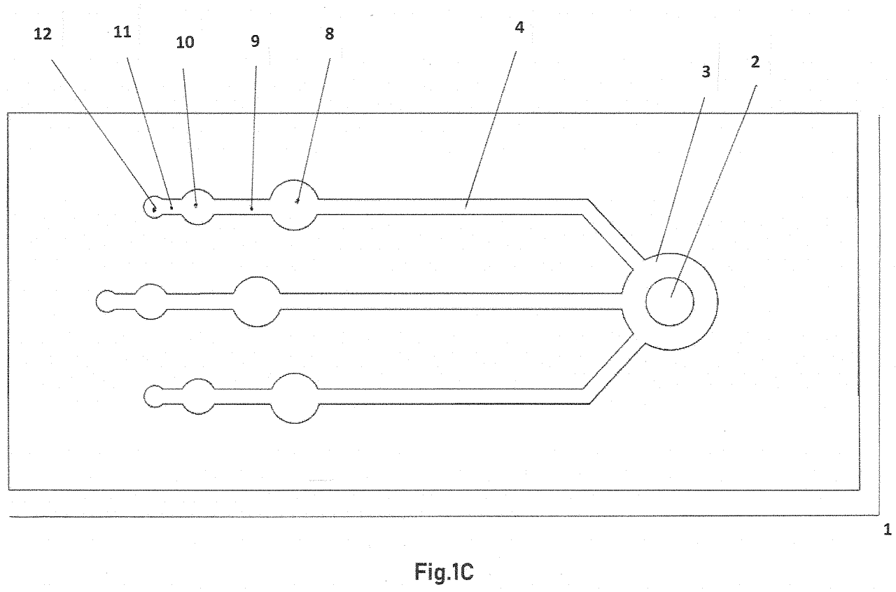

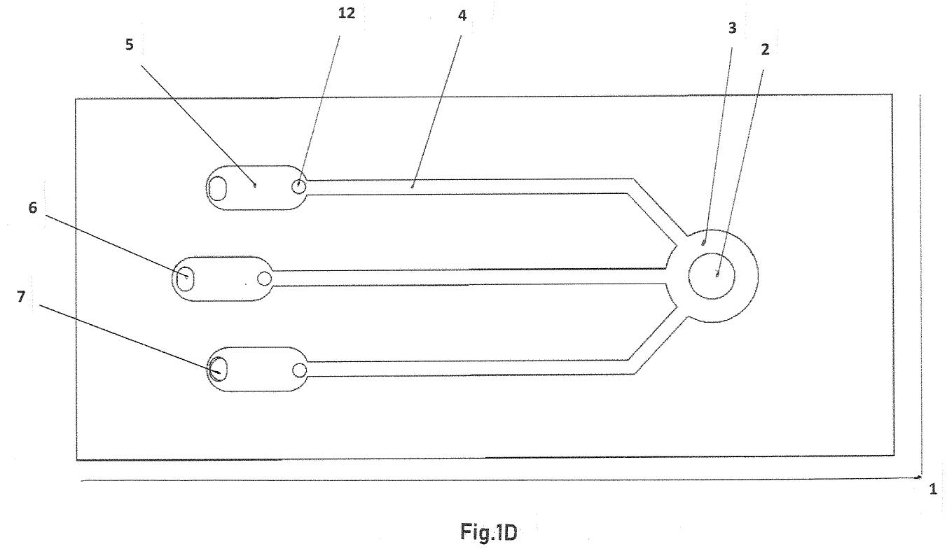

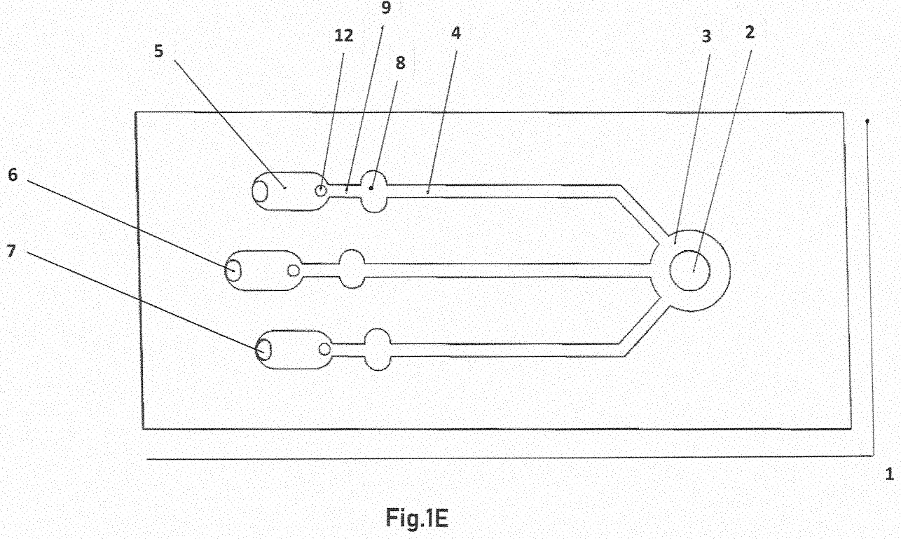

FIG. 1 depicts five embodiments of the assay card (1). The assay card (1) comprises polymer and/or thermoplastic layers attached to a flat and/or curved surface. The polymer and/or thermoplastic layers are arranged to define a sample input chamber (2) with an outside opening, an optional fluid reservoir (3), and at least two self-contained microchannels (4). Additional microchannels (9, 11) can also be present. In addition, some combination of one or more detection chambers (5), reaction chambers (8), signal chambers (10), and/or combinations thereof can be present. In some embodiments a vent (12) that is open to the air is present. The detection chamber (5) and/or the signal chamber (10), can be sealed but configured to be visible or can have an outside opening.

Suitable polymers and/or thermoplastics for the assay card (1) are primarily non-porous and/or can be treated with an agent to increase and/or achieve non-porosity, such as, but without limitation, application of a thin film of aluminum. Examples of suitable polymers and/or thermoplastics include, but are not limited to, polydimethylsiloxane (PDMS; Tsao (2016) Micromachines 7:225-235), polyethylene terephthalate (PET), polymethylmethacrylate (PMMA), polycarbonate (PC), polyvinyl chloride (PVC), polystyrene (PS), polyether ether ketone (PEEK), polytetrafluoroethylene (PTFE), fluorinated ethylene propylene (FEP), and polyimide (Pi). In addition, cyclic olefin polymers including, but not limited to, cyclic olefin copolymer (COC), cyclic olefin polymer (COP), and cyclic block copolymer (CBC) can be used.

The polymer and/or thermoplastic layers can be attached to the flat and/or curved surface by standard methods such as lamination, thermoforming, injection molding, and 3D printing.

One production method that can be used for generating microchannels via lamination relies on generating at least three layers; a bottom layer, one or more middle layers, and a top layer. The bottom layer serves as a support and is made of a polycarbonate, such as but not limited to, Lexan model 8010 or polyethylene terephthalate (PET) that can range in thickness from 0.0254-2.5 mm, 0.0508-1.27 mm, 0.096-0.96 mm, 0.96-0.125 mm, 0.125-0.152 mm, 0.1524-0.8128 mm, 0.2032-0.762 mm, 0.215-0.502 mm, or 0.254-0.3048 mm. Suitable bottom layer polycarbonates include, but are not limited to, polyethylene terephthalate (PET). In some embodiments the bottom layer is reinforced with one or more hydrophilic film materials such as, but not limited to, 3M™ 9962 and/or with one or more polyester microfluidic tapes, such as, but not limited to, 3M™ 9965 (3M™, Minnesota). In these cases, the bottom layer can range in thickness from 0.0508-1.27 mm, 0.096-0.96 mm, 0.96-0.125 mm, 0.125-0.152 mm, 0.152-0.285 mm, 0.285-0.8128 mm, 0.2032-0.762 mm, 0.215-0.502 mm, or 0.254-0.3048 mm.

The one or more middle layers define the channel(s) and can be generated by layering. Appropriate materials include polyester films, but are not limited to, for example ARCARE® 90445, ARFLOW® 93049 (Adhesives Research, Pennsylvania), 3M™ 7945, 3 M™ 7959, 3 M™ 9960 and 3M™ 9962 (3M™, Minnesota). In some instances, one layer may be comprised of a laminate of materials such as, AR 93049 and AR 90445. One or more separate layers may be comprised of a laminate of 3M™ 7945 and 3M™ 9962, 3 M 7959 and 3M™ 9960, 3M 7945 and 3M™ 9960, and/or combinations thereof. The thickness of each of the laminated layers can range from 0.0254-2.5 mm, 0.0508-1.27 mm, 0.096-0.96 mm, 0.96-0.125 mm, 0.125-0.175 mm, 0.1524-0.8128 mm, 0.2-0.762 mm, 0.215-0.502 mm, or 0.254-0.3 mm, 0.2-0.4 mm.

The microchannels and chambers are cut into the one or more middle layers using standard methods such as, but not limited to, cutting plotters, notch-cutting, stamping including that conducted with an electromagnetic press or servo press, and laser processing (e.g. UNIVERSAL LASER SYSTEMS®, “Laser Processing of 3M™ 9960 Diagnostic Microfluidic Hydrophilic Film” available on the internet).

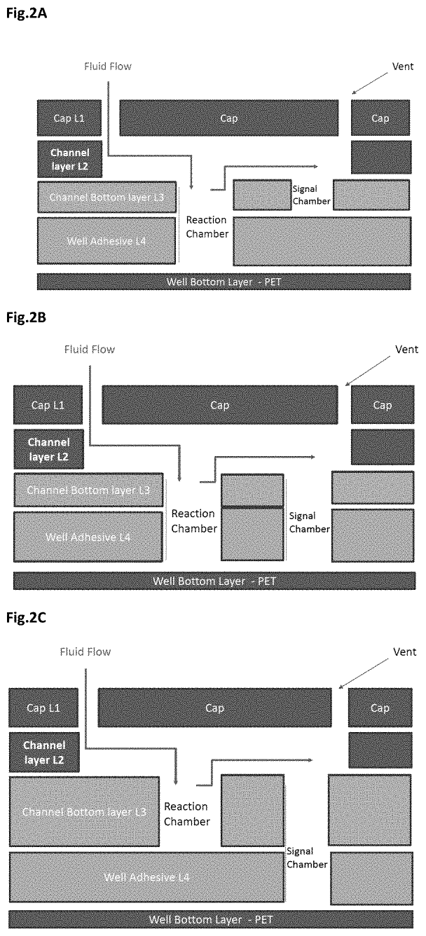

The microchannels, chambers, and optional fluid reservoir are cut to a size appropriate for the type and quantity of sample as well as the type, size, and quantity of the nanoparticles. As seen in FIG. 2, the reaction chamber can have a greater volume than the signal chamber, the reaction chamber and signal chamber can have essentially equal volumes, or in the signal chamber can have a greater volume than the reaction chamber. Channels, chambers and optional fluid reservoir can therefore accommodate sample volumes falling within a volume ranging from 5 μl to 5000 μl, such as from 10 μl to 4000 μl, such as from 15 μl to 3000 μl, such as from 20 μl to 2000 μl, such as from 25 μl to 1000 μl, such as from 30 μl to 500 μl, such as from 40 μl to 400 μl, such as from 50 μl to 300 μl and including from 75 μl to 250 μl.

In some embodiments, the flow microchannels are configured to have a cross-sectional height which is substantially equivalent to the dimensions of the target analyte. By “substantially equivalent” to the dimensions of the target analyte is meant that one or more of the height or width of the flow microchannel differs from the size of the target analyte by 100% or less, 75% or less, 50% or less, 25% or less, 10% or less, 5% or less, 4% or less, 3% or less, 2% or less, 1% or less, 0.5% or less, 0.1% or less and including 0.01% or less. In these embodiments, the cross-sectional dimensions of the flow microchannel are substantially the same as the size of the target analyte and the cross-sectional dimensions are configured to allow target analyte flow through the microchannel one analyte at a time.

In certain instances, the target analyte is a cell such as, without limitation, bacteria, fungi, algae, sperm, or blood cells. In other instances the target analyte is, without limitation, a metabolite (e.g., ATP, NADP, carnosine, ophthalmic acid, glutathione, uric acid, glucose, aflatoxin, etc.), a drug (e.g., cortisol, antibiotics, caffeine, cannabinoids, etc.), a pollutant (e.g., lead, E. coli, organic solvent, arsenic, cholera toxin, etc.), a protein (e.g., albumin, myosin, alfa-fetoprotein (AFP), hepcidin, etc.), a hormone (e.g., thyroid stimulating hormone (TSH), thyroxine (T4) and triiodothyronine (T3), adrenocorticotropic hormone (ACTH), testosterone, anti-Mullerian hormone (AMH), human chorionic gonadotropin (hCG), thymosins, inhibin A, FSH, LH, estriol (μE3), estradiol (E2), and progesterone, etc.), a nucleic acid (e.g. DNA (single stranded DNA or double stranded DNA), RNA, miRNA, oligonucleotides, and synthetic nucleotides, etc.), antibodies (e.g. RA (rheumatoid arthritis) factor, anti-thyroid autoantibody, antinuclear antibodies (ANA), anti-transglutimase, and anti-cyclic citrullinated pepti de, etc.), and/or combinations thereof.

The cross-sectional shape of the microchannel may vary in different embodiments or upon a single assay card, where examples of cross-sectional shapes include, but are not limited to rectilinear cross-sectional shapes, e.g., squares, rectangles, trapezoids, triangles, hexagons, etc., curvilinear cross-sectional shapes, e.g., circles, ovals, etc., as well as irregular shapes, e.g., a parabolic bottom portion coupled to a planar top portion, etc. In addition, the cross-sectional dimensions of the microchannel may vary, ranging from 0.01 mm to 25 mm, such as from 0.05 mm to 22.5 mm, such as from 0.1 mm to 20 mm, such as from 0.5 mm to 17.5 mm, such as from 1 mm to 15 mm, such as from 2 mm to 12.5 mm, such as from 3 mm to 10 mm and including from 5 mm to 10 mm. For example, where the flow channel is cylindrical, the diameter of the flow channel may range from 0.01 mm to 25 mm, such as from 0.05 mm to 22.5 mm, such as from 0.1 mm to 20 mm, such as from 0.5 mm to 15 mm, such as from 1 mm to 10 mm, and including from 3 mm to 5 mm.

Once the one or more middle layers are constructed and the microchannels and chambers formed, they are laminated to the bottom layer.

Appropriate nanoparticles are inserted into the detection chamber and/or reaction chamber. This is typically done by preparing an agarose, acrylamide, and/or hydrogel loading/immobilization gel. Suitable hydrogels include, but are not limited to, naturally occurring materials such as chitosan, gellan gum, kelp calcium alginate, kelp sodium alginate, etc., non-naturally occurring crosslinked materials such as polyacrylamide, polyethylene glycol (PEG), PEG-DTT, polyacrylic acid, polyvinyl alcohol, polyvinylpyrrolidone, polysaccharides, etc., and hybrid materials such as Hydroplan-EB. Agarose, acrylamide, and hydrogels are prepared according to the manufacturer's instructions and prepared nanoparticles mixed into the loading/immobilization gel prior to loading into the detection and/or reaction chambers. Loading can be accomplished by pipetting (manual or automatic) or in some cases via acoustic droplet ejection technology (e.g. ECHO® 650 (Labcyte, California)).

In embodiments where concentration of signal is desired, an appropriate signal concentration pad/material is placed within the detection chamber or the signal chamber as discussed below.

After insertion of the nanoparticles into the detection (5) and/or reaction (8) chamber(s), and placement of any signal concentration pad/material into the detection (5) or signal (10) chamber(s), the top layer is applied and acts as a seal, ensuring that the sample is contained within the microchannels (4, 9, 11) and chambers (2, 5, 8, 10) of the assay card (1) as well as containing the nanoparticles in the detection (5) and/or reaction (8) chamber(s). In some embodiments the top layer is a transparent PET polymer. This allows visualization into the detection (5) and/or signal (10) chamber(s) through the detection windows (24) when the optional device cartridge (20) is used. In some embodiments the top layer may contain one or more vents (6, 12) that are open to the air at the terminus of the microchannels (4, 9, 11) to facilitate flow rate. The top layer can range in thickness from 0.0254-2.5 mm, 0.0508-1.27 mm, 0.096-0.96 mm, 0.96-0.125 mm, 0.125-0.152 mm, 0.1524-0.8128 mm, 0.2032-0.762 mm, 0.215-0.502 mm, or 0.254-0.3048 mm.

The top layer is applied to the one or more middle layers using pressure, then placed into a heated press for approximately 30 seconds at temperatures ranging from 20° F. to 500° F., such as from 30° F. to 400° F., such as from 40° F. to 300° F., such as from 50° F. to 250° F., such as from 60° F. to 200° F., such as 70° F. to 150° F., such as from 75° F. to 100° F., and including from 100° F. to 150° F.

Nonlimiting examples of layer materials and position are shown in the chart below.

| | | | | Thickness | Thickness | |
|---|---|---|---|---|---|---|
| | | | AM-000119 V4 | (mils) | (mm) | Notes |
| V4-1 | Layer 1 | Capping | 5 mil PET | 5 | 0.125 | 2 wells, reaction deeper than signal |
| .2 mm | Layer 2 | Channal | AR 93049 + 90445 | 7 | 0.175 | |
| | Layer 3 | Signal | 3M 7945 + 9962 | 8 | 0.2 | |
| | Layer 4 | Reaction | 3M 7945 + 9962 | 8 | 0.2 | |
| | Layer 5 | Bottom | 5 mil PET + 3M9665 + 3M9962 | 11.5 | 0.285 | |
| V4-2 | Layer 1 | Capping | 5 mil PET | 5 | 0.125 | 2 wells, reaction and signal same depth |
| .4 mm | Layer 2 | Channal | AR 93049 + 90445 | 7 | 0.175 | |
| | Layer 3 | Signal Reaction | 3M 7959 + 9960 | 16 | 0.4 | |
| | NA | | | | | |
| | Layer 4 | Bottom | 5 mil PET + 3M9665 + 3M9962 | 11.5 | 0.285 | |
| V4-3 | Layer 1 | Capping | 5 mil PET | 5 | 0.125 | 2 wells, signal Deeper than reaction |
| .7 mm | Layer 2 | Channal | AR 93049 + 90445 | 7 | 0.175 | |
| | Layer 3 | Reaction | 3M 7959 + 9960 | 16 | 0.4 | |
| | Layer 4 | Signal | 3M 7945 + 9960 | 12 | 0.3 | |
| | Layer 5 | Bottom | 5 mil PET + 3M9965 + 3M9962 | 11.5 | | |

Referring to FIG. 1, the assay card (1) has a sample input chamber (2) to which a solution sample is applied. The sample application site of the microfluidic assay card is a structure configured to receive a sample having a volume ranging from 5 μl to 1000 μl, such as from 10 μl to 900 μl, such as from 15 μl to 800 μl, such as from 20 μl to 700 μl, such as from 25 μl to 600 μl, such as from 30 μl to 500 μl, such as from 40 μl to 400 μl, such as from 50 μl to 300 μl, such as from 75 μl to 250 μl, such as from 100-130 μl, and including from 100-150 μl. The sample input chamber may be any convenient shape, so long as it provides for fluid access, either directly or through an intervening component that provides for fluidic communication, to the microchannel. In some embodiments, the sample input chamber is planar. In other embodiments, the sample input chamber is concave, such as, but not limited to, the shape of an inverted cone terminating at the sample inlet orifice. Depending on the amount of sample applied and the shape of the sample input chamber, the sample input chamber may have a surface area ranging from 0.01 mm² to 1000 mm², such as from 0.05 mm² to 900 mm², such as from 0.1 mm² to 800 mm², such as from 0.5 mm² to 700 mm², such as from 1 mm² to 600 mm², such as from 2 mm² to 500 mm², such as from 2 mm² to 6 mm² such as from 5 mm² to 250 mm², and including from 6 mm² to 100 mm².

In some embodiments the outside opening to the sample input chamber is smaller than the boundaries/walls of the chamber so that the sample input chamber is essentially a fluid/solution reservoir (3). In other embodiments the outside opening to the sample input chamber is equal to the space defined by the walls of the chamber or of the diameter of the chamber in the case of a circular chamber. The sample input chamber is connected to at least two microchannels (4), each microchannel (4) creating a capillary flow path for the solution sample. No reactions occur within the microchannels (4) and there is no interaction between the at least two microchannels (4). Once sample enters a microchannel (4), it remains isolated from sample that has entered a different microchannel (4).

Each of the microchannels (4) terminates in either a detection chamber (5) or a reaction chamber (8). In some embodiments, a second set and/or third set of microchannels (9, 11) may exist; one set of at least two microchannels (4) located between, and connected to, the sample input chamber (2) and the reaction chamber (8), a second set of microchannels (9) located between, and connected to, the reaction chamber (8) and the detection chamber (5) or the signal chamber (10) and a third set of microchannels (11) located terminal to the signal chamber (10). The microchannels (4, 9, 11) define empty space and are formed as described above. Depending on the solution components to be identified, the internal dimensions of the microchannels (4, 9, 11) are adjusted to accommodate target component size and/or volume of sample needed. In every case, however, movement of the sample through the microchannels (4, 9, 11) occurs only via capillary action. Microchannels (4, 9, 11) are essentially free of reagents and do not provide for any intentional reaction with the sample. The term “essentially free” is meant to indicate that 1% or less of the microchannels (4, 9, 11) contain any non-gaseous factor, such as 0.9% or less, such as 0.8% or less, such as 0.7% or less, such as 0.5% or less, such as 0.1% or less, such as 0.05% or less, such as 0.01% or less, such as 0.001% or less, and including where 0.0001% or less of the microchannels (4, 9, 11) contain non-gaseous factors.

The capillary action provided by the microchannels (4, 9, 11) delivers sample solution to the detection chamber (5) or reaction chamber (8), where at least one solution component is identified. Each detection chamber (5) and/or reaction chamber (8) contains nanoparticles designed to identify a specific solution component. Typically, each detection chamber (5) and/or reaction chamber (8) contains nanoparticles directed to identify only one target solution component or molecule, although identification of more than one solution component or molecule in each detection chamber (5) and/or reaction chamber (8) can be achieved as described below. Suitable nanoparticles are made of metal, metalloids, clay, polymers, hydrogels, silica, mesoporous silica, or combinations thereof (e.g. U.S. Pat. No. 8,455,255, CN 106053805, and US 2006/257,958). In some cases, the surface of the nanoparticle is modified with, for example but without limitation, polycations, polyethyleneimine, lipids, or NH₂. While nonporous nanoparticles may be best suited to some applications, porous nanoparticles have advantages for other applications. As an example, nonporous nanoparticles may be more effective when it is desirable to eliminate particular molecules from a sample so that those undesirable molecules bind to a nonporous molecule containing a binding partner attached to their surface so that the desired molecule would continue to the detection or signal chamber. Yet in some cases porous nanoparticles are preferred for assaying for specific molecules. In this case, the nanoparticles are loaded with dyes that serve as reporter molecule when antigen binds a pore gating antibody/aptamer/other molecule, thereby releasing the reporter molecules from the nanoparticle pore.

Porous nanoparticles such as, but without limitation, MCM-41, MCM-48, MCM-50, AMS-6 (lad), NFM-1, FDU-1(1 mm), SBA-1 (Pmn), SBA-11, SBA-12, SBA-16, AMS-8(Fdm), TUD-1, HMM-33, FSM-16, KIT-5, COK-12, zeolites, and SBA-15 permit loading guest or cargo molecules into the nanopores. Nonlimiting examples of cargo molecules include chemotoxic molecules (e.g. cisplatin, 5-flurouracil, etc.), chemotherapeutic/drug molecules (e.g. antibiotics, estrogen, androgen, etc.), fluorescent proteins (e.g. green fluorescent protein (GFP), Ds-Red fluorescent protein, kusabira orange, etc.), fluorescent dyes (e.g. fluorescein, Calcein, Fluo-4, etc.), or visual dyes (e.g. methylene blue, Safranin-O, vinyl sulfone dyes, etc.). In addition, cargo molecules can be metal-based pigments (e.g. manganese violet, venetian red, cobalt blue, etc.), inorganic pigments (e.g. carbon black, ultramarine, yellow ochre, etc.), biological pigments (e.g. indigo, tyrian purple, Indian yellow, etc.) and organic pigments (e.g. magenta, phthalocyanine green, phthalocyanine blue, etc.). Combinations of different types of cargo molecules can also be used, such as a combination of fluorescent and visual dyes or a combination of a visual dye and a metal-based pigment.

Visual dyes have some advantages in that no further treatment must be performed (e.g. illumination with UV light, etc.) and can be easily concentrated in the detection chamber (5) or signal chamber (10). Examples of suitable visual dyes include: Remazol red, Remazol turquoise, Remazol orange, Remazol black B, Safranin-O, Methylene blue, Bromocresol green, Bromocresol violet, Phenolphatalein, Sunset yellow FCF, Brilliant blue FCF, Crystal violet, Alcian blue, Rhodamin B, and Chromotrope 2R.

Other cargo molecules include, but are not limited to: 2,3-Diaminonaphthalene; 2,3,7,8,12,13,17,18-Octaethyl-21H,23H-porphine iron (III) chloride; 2,4-Dinitrohydrazine; 2,7-Dichlorofluoresceine; 3,3′-Dimethyoxybenzidine; 4-(4-Nitrobenzyl)pyridine+N-benzylaniline; 5,10,15,20-Tetraphenyl-21H,23H-porphine cobalt (II); 5,10,15,20-Tetraphenyl-21H,23H-porphine copper (II), 5,10,15,20-Tetraphenyl-21H,23H-porphine manganese (III) chloride; 5,10,15,20-Tetraphenyl-21H,23H-porphine; 5,10,15,20-Tetraphenyl-21H,23H-phophine ruthenium(II) carbonyl; 5,10,15,20-Tetraphenyl-21H,23H-porphine zinc; Alizarin; Bismuth neodecanoate; Brilliant Yellow; Brilliant Yellow+TBAOH; Bromocresol Green; Bromocresol Green+TBAOH; Bromocresol Purple; Bromophenol Blue; Bromophenol Blue+TBAOH; Bromophenol Blue+TsOH; Bromothymol Blue+TsOH; Bromophenol Red; Bromophenol Red+TBAOH; Bromophenol Red+TsOH; Bromothymol Blue+TBAOH; Chlorophenol Red; Chlorophenyl Red+TBAOH; Copper(II) acetylacetonate; Copper(II) neodecanoate; m-Cresol Purple; m-Cresol Purple+TBAOH; Cresol Red; Cresol Red+TBAOH; o-dianisidine+TsOH; Diphenylamine+TsOH; N,N′-Diphenyl-N,N′-di-p-tolylbenzene-1,4-diamine+TsOH; Disperse Orange 25; Lead(II) acetate; Lead(II) acetate trihydrate; Lissamine Green B; Lithium nitrate+Cresol Red; Malachite Green; Mercury(II) bromide+meso-tetra(2,4,6-trimethylphenyl)porphine; Mercury(II) chloride+Bromocresol Green+TBAOH; Methyl Red; Methyl Red+TBAOH; Mercury(II) chloride+Bromophenol Blue+TBAOH; Napthyl Blue Black; Nile Red; Nitrazine Yellow; Nitrazine Yellow+TBAOH; Palladium(II) sulfate; Phenol Red; Phenol Red+TBAOH; Phloroglucinol; o-Phenylenediamine; Pyrocatechol Violet; Reichardt's Dye+TBAOH; Silver nitrate+Bromophenol Blue+TBAOH; Silver nitrate+Cresol Red+TsOH; Tetracyanoethylene; Tetraiodophenolsulfonephthalein; Thymol Blue; Thymol Blue+TBAOH; o-Tolidine; and Zn(II) acetate+m-Cresol Purple+TBAOH.

Cargo molecules are kept in place within the nanoparticle's nanopores by formation of a nanovalve or molecular gate. Briefly, a nanovalve/molecular gate is formed by attaching a molecule to the surface of the nanoparticle such that it covers the opening of the nanopore containing the guest molecules, acting as a gatekeeper. In response to an environmental cue, such as binding an antigen or ligand, the molecular gatekeeping molecule is shifted, removed, or reconfigured resulting in the opening of the nanopore and allowing release of the guest molecules. Gated nanoparticles are known in the art (e.g. U.S. Pat. Nos. 9,260,656 and 8,486,528) and have been used to deliver drugs to tumors or to identify cancer associated proteins (e.g. US 2017/173,169, U.S. Pat. No. 8,409,876, and WO 2016/007,919).

Gatekeeping molecules are selected in view of the intended target component of the solution. Suitable gatekeeping molecules include, but are not limited to, DNA, RNA, aptamers, antibodies, haptens, proteins, peptides, oligonucleotides, glycoproteins, glycolipids, proteoglycans, monosaccharides, polysaccharides, cellulose, and fluorescent dyes. For example, if the target component of the solution is lead (Pb(II)) ions in drinking water, an appropriate gatekeeper could be an Anti-Pb(II)-ITCBE monoclonal antibody (Kuang et al. (2013) Sensors (Basel) 31(4):4214-4224). Alternatively, if the target molecule is an antibiotic, such as tetracycline or neomycin, then an appropriate aptamer can serve as the gatekeeper (see, for example, Piro et al. (2016) Biosensors (Basel) 6(1):7).

Whatever gatekeeping molecule is ultimately selected, interaction with its target molecule results in the opening of the nanopore, which allows the sequestered cargo molecules to escape from the nanoparticle. This can be accomplished by a conformational change in the gatekeeping molecule, which may cause a shift in the placement of the gatekeeper on the surface of the nanoparticle, or by causing the gatekeeping molecule to totally or partially detach from the nanoparticle. If no target is present in the solution sample, the gatekeeping molecule remains in place blocking the opening to the nanopore and the cargo molecules remain within the nanopore. When there is a target-gatekeeper interaction, upon release of the cargo molecules from the nanopore, the cargo molecules are detected without the application of external energy.

In some embodiments, the gatekeeping molecule remains intact, but is simply lifted away from the nanoparticle. Here, the nanoparticles are coated with a branched cationic polymer polyethylenimine (PEI) or a similar molecule, such as, without limitation, poly-L-lysine (PLL), poly(amidoamine) (PAMAM), poly(2-dimethylaminoethyl methacrylate) (pDMAEMA), diethylaminoethyl-dextran (DEAE-DEX), chitosan, and other polymethacrylates (PMA). “Naked” silica mesoporous particles are negatively charged, and the PEI or similar molecule adheres to the nanoparticle surface via non-covalent forces, creating a surface with a net positive charge. Without being limited to any particular mechanism, examples of such non-covalent forces are electrostatic interactions, hydrogen bonds, van der Waals forces, and hydrophobic interactions.

Similarly, bonds between a protein and PEI are noncovalent and can be maintained due to charge interactions. Consequently, anionic proteins, such as, without limitation, antibodies carrying multiple negative charges, are generally expected to non-covalently bind positively charged surfaces. This interaction is enhanced by aggregation of antibodies on the PEI-coated silica surfaces. As a result, when the gatekeeping protein interacts with its analyte (e.g. an antibody-antigen interaction), the charge associated with the gatekeeping protein-analyte complex changes and the existing non-covalent forces are no longer able to maintain association of the gatekeeping protein-analyte complex with the nanoparticle, thereby releasing the complex into the surrounding solution. The release of the gatekeeping protein-analyte complex from the nanoparticle opens the nanopore, allowing release of any cargo/reporter molecules sequestered within the pores.

In some cases, concentration of the cargo molecules can be advantageous. Concentration of the cargo molecules can be achieved by placing a signal concentration pad (7) at the far end of the detection chamber (5) and/or the signal chamber (10); i.e. at the distal end of the detection chamber (5) and/or the signal chamber (10) in relation to the microchannel (4 or 9) leading to the detection chamber (5) and/or the signal chamber (10). The signal concentration pad (7) can be any material suitable for absorbing the released cargo molecules. Examples of suitable signal concentration pad (7) materials include, but are not limited to, nitrocellulose, WHATMAN® Protran BA 85, WHATMAN® Protran BA 83, nylon, PVDF, cellulose (e.g. WHATMAN® qualitative filter paper, Grade 1 (catalogue no. WHA1001090), WHATMAN® qualitative filter paper, Grade 2 (catalogue no. WHA1002150), etc.), and the like. The assay card (1) can include an optional vent (6) which is located immediately over the cargo concentration pad and which is open to the air as shown in FIGS. 1A and 1B.

In some instances, the cargo-loaded nanoparticles reside within a separate reaction chamber (see FIGS. 1B and 1C). Here, the cargo molecules released from the nanopores in the reaction chamber (8) travel by capillary action to the detection chamber (5) and/or signal chamber (10) via a connecting microchannel (9). An optional signal concentration pad (7) may be placed in the detection chamber (5) and/or signal chamber (10) to facilitate detection.

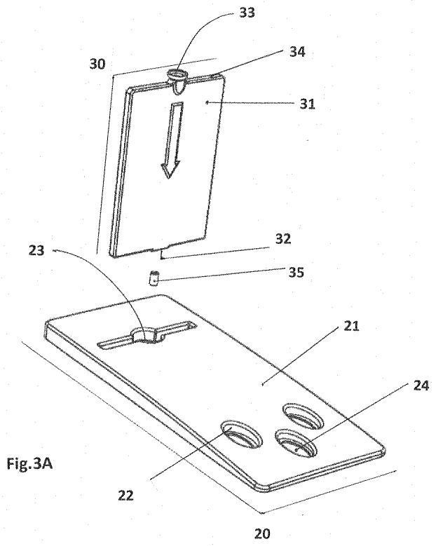

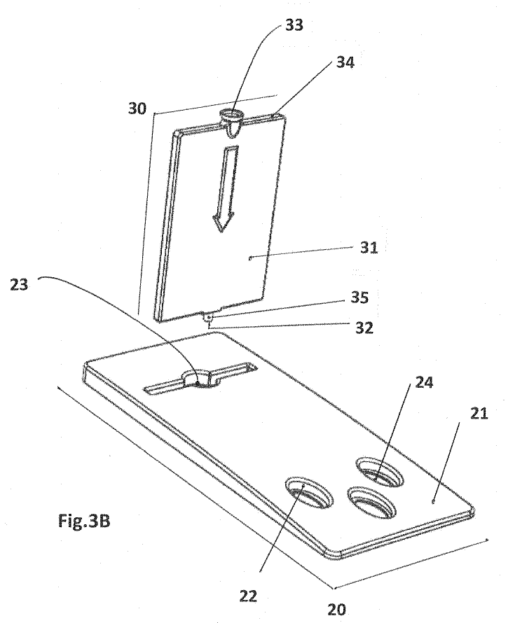

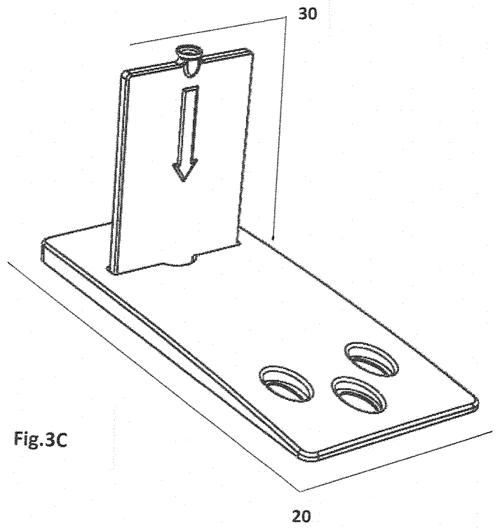

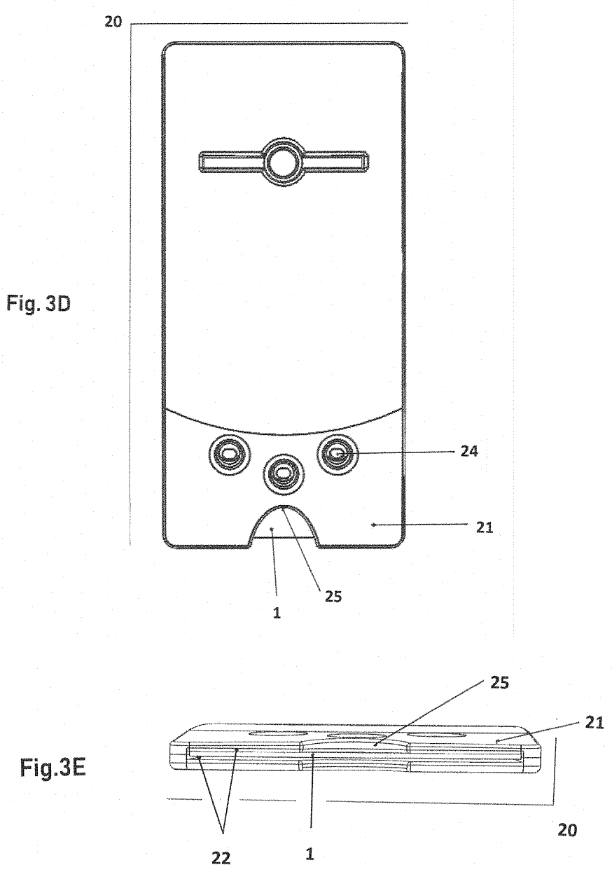

The assay card (1) can be placed within an optional single or multiple use device cartridge (20) for protection from the elements and to decrease contamination by users. FIG. 3 represents one embodiment of the optional device cartridge (20). The optional device cartridge (20) comprises a housing (21), an interior chamber (22) suitable to hold the assay card (1) in place, a sample input port (23) where solution sample is applied, and at least two detection windows (24). The optional device cartridge (20) is configured so that the sample input port (23) is immediately over the sample input chamber (2) once the assay card (1) is inserted into the interior chamber (22). Similarly, the at least two detection windows (24) are configured in the optional device cartridge (20) so that they are located immediately over the detection chamber (5), optional vent (6), and/or signal chamber (10). In other words, the openings of the optional device cartridge (20) are arranged to reflect the arrangement of the sample input chamber (2) and detection chamber (5), optional vent (6), and/or signal chamber (10) of the assay card (1) to allow easy sample application and easy and/or visible detection.

The optional device cartridge (20) can be made of durable materials such as, but not limited to, plastics (e.g. acrylonitrile butadiene styrene (ABS), polycarbonate, polyphenylsulfone (PPSU), Ultra High Molecular Weight (UHMW) polyethylene, polyethylene tetrafluoroethylene (ETFE), fluorinated ethylene propylene (FEP), high impact polystyrene, etc.) and metals (e.g. alloys of aluminum, magnesium, titanium, beryllium, etc.) using standard manufacturing practices.

For some applications the system includes an optional reagent container (30) comprising a reagent container housing (31), an outlet port (32) and an optional inlet port (33), each of which is connected to an interior chamber (34). The optional reagent container (30) can provide mixing of the solution sample with buffer that is selected according to the solution sample of interest. When buffer is used, it resides within the interior chamber (34) of the reagent container housing (31), either in direct contact with the walls of the optional reagent container housing (31) or within a separate, fallible container within the interior chamber (34), such as a blister pack or bubble pack made from thermoformed plastic.

When buffer is in direct contact with the walls of the optional reagent container housing (31), it is held in place by pierceable seals covering the outlet port (32) and the optional inlet port (33). Pierceable seals, such as foil and polyester seals, are commercially available. The optional reagent container (30) can be connected to the optional device cartridge (20) using an optional connector (35), which fits snugly in the sample input port (23) and over which the optional reagent container outlet port (32) fits snugly, thereby minimizing reagent leakage. When the reagent container outlet port (32) has a pierceable seal, the optional connector (35) can have sharp protrusions capable of piercing the seal and allowing the flow of the reagent contained within.

Suitable materials for the optional reagent container (30) include durable plastics and/or metals, such as those used for the optional device cartridge (20). However, when the optional reagent container (30) contains a separate, fallible container in the interior chamber (34), the optional reagent container (30) is formed from durable plastics and/or metals with sufficient flexibility to allow release of the buffer from the separate, fallible container upon pressure to the reagent container housing (31) by the user. Non-limiting examples of such plastics are ethylene vinyl acetate copolymer (EVA), fluorinated ethylene-propylene (FEP), and low density polyethylene (LDPE).

### Method of Using the Assay System

Different types of solutions can be assayed using the disclosed system. In some instances, the solution is collected from an environmental source, such as, without limitation, a lake, stream, river, ocean, reservoir, water treatment plant, water storage container (e.g. water tower, water heaters, water tanks, etc.), and/or water transit container (e.g. pipe, sewage systems, etc.). In some instances, the solution is an organic solution, such as, without limitation, those found in refrigerant (e.g. solutions of fluorocarbons, chlorofluorocarbons, non-halogenated hydrocarbons, hydrofluorocarbons, hydrochlorofluorocarbons, perfluorocarbons, dimethyl ether, etc.), crude or processed oil, heating oil treatments, synthetic oil, vegetable oils, lubricants, and the like.

In other instances, the solution is a biological solution. While all biological solutions can be used, in some cases the solution is a blood sample, including whole blood, such as blood obtained from venipuncture or fingerstick, which may or may not be combined with any reagents prior to assay, such as preservatives, buffers, anticoagulants, etc. In yet other instances the source of the solution is a mammal, including humans. For humans, the biological solution may be obtained from humans of either and/or both genders and at any stage of development (i.e., neonates, infant, juvenile, adolescent, adult).

Referring to FIG. 1, to use the system, the user places an appropriate quantity of test solution onto the opening of the sample input chamber (2) of the assay card (1). The solution may be applied to the sample input chamber using any convenient protocol, e.g., via direct application from the source, dropper, pipette, syringe and the like.

The solution may be applied in conjunction with or incorporated into a quantity of a suitable liquid, e.g., buffer, to provide for adequate fluid flow, for example by use of the optional reagent container (30). Any suitable liquid may be used, including but not limited to buffers, cell culture media (e.g., DMEM, Luria broth, MSO, etc.), solvents, etc. Buffers include, but are not limited to: tris, tricine, MOPS, HEPES, PIPES, MES, PBS, TBS, and the like. Where desired, detergents may be present in the liquid, e.g., NP-40, TWEEN™, or TritonX100 detergents.

Placement of the test solution into the opening of the sample input chamber (2) is done directly or through the sample input port (23) of the optional device cartridge (20). In some instances, the solution sample may be pre-processed by movement through a filter or filtration system having a pore size of 0.45μ, and/or 0.22μ to remove cells, particulate matter, and/or aggregates prior to application of the solution sample to the assay card (1). When the solution sample comprises blood, saliva, sweat, or urine, pre-processing can be conducted using, for example, the SIPON™ (GattaCo, Palm Springs, Calif.).

Once test solution has been applied to the assay card (1), the solution passes through the microchannels (4, 9, 11) only via capillary action to the detection chamber (5), reaction chamber (8), and/or signal chamber (10). In some embodiments the test solution first passes through a separate reaction chamber (8) prior to entering the detection chamber (5) or signal chamber (10). In either case, the test solution interacts with porous nanoparticles loaded with an appropriate cargo or reporter molecule and gated with a ligand which targets a particular analyte to be identified and/or quantitated in the test solution. After a subsequent release of the cargo or reporter molecules from the gated nanoparticles, the cargo or reporter molecules can be concentrated on an optional signal concentration pad (7) in the detection chamber (5) and/or signal chamber (10). The optional signal concentration pad (7) is visible through the vent (6) and/or signal chamber (10) on the assay card (1) and, if the optional device cartridge (20) is used, through the detection window (24).

In instances where fluorescent and/or visible dyes or pigments are used as cargo molecules, a photographic image of the concentrated cargo molecules appearing in the detection chamber (5), optional signal concentration pad (7), and/or signal chamber (10) is taken. The photographic image is then uploaded, and the amount of signal generated by the fluorescent and/or visible dyes or pigment detected using software such as that disclosed in GB1721811.6 and/or U.S. Pat. No. 9,903,857. This allows rapid analysis of the target analyte(s) to occur at the point of collection/assay or at some remote location.

### EXAMPLES

### Example 1—Preparation of Anti-Thyroid Stimulating Hormone (TSH) Antibody Gated Nanoparticles

### Preparation of Mesoporous Silica Nanoparticles for Cargo Loading

20 mg of mesoporous silica nanoparticles (“MSN”), MCM-41 (hexagonal, Cas #: 7631-86-9, Sigma Aldrich 643645) or SBA-15 (hexagonal, Cas #: 7931-86-9, Sigma Aldrich 806854) were washed with 5 ml of acidified methanol (1:50 v/v, methanol 99%, HC137% stock solutions) for 15 minutes. The MSN were then pelleted by brief centrifugation (2000 g for 2 minutes) and the supernatant removed. The MSN were washed with 10 ml of pure water (Millipore, 18 mΩ) by gentle agitation on a rotator and centrifuged as above to remove acidified methanol.

### Surface Modification of MSN

Washed MSN were resuspended in 4 ml H₂O supplemented with 30 mg of Polyethyleneimine (“PEI”; branched, CAS:9002-98-6, Alfa Aesar 40527) and gently mixed for 20 minutes on a benchtop tube rotator at room temperature to coat outer surfaces of the silica. PEI modifies the surface charge properties and created a positively charged MSN suitable for antibody attachment. Excess PEI was removed by centrifugation and MSN were washed twice with 5 ml of pure Millipore grade water.

### Cargo/Reporter Dye Loading of MSN

The particles resuspended in cargo loading solution, 2 ml of 2 mM acetic acid supplemented with reporter dye (Methylene blue) at 1 mg/ml final concentration. The solution was then briefly degassed (10 minutes in a vacuum chamber) to displace residual air and facilitate efficient loading of cargo into hollow cavities of MCM-41 and/or SBA-15. Dye loading was done by continuous gentle mixing of the mixture on a tube rotator. This process continued for 10-14 hours at room temperature.

### Anti-TSH Antibody Capping of Reporter Dye Loaded MSN

The cargo loading solution was removed by centrifugation and first washed once with 2 mM acetic acid. The washing step was repeated with phosphate buffered saline “PBS” (pH=7.2). MSN were then resuspended in PBS (pH=7.2) containing between 2-24 μg of gating anti-TSH antibody per mg of surface modified reporter dye loaded MSN. As a control anti-Myo7a human protein antibody in PBS (12 μg/mg MCM-41 or SBA-15) was used to cap reporter dye loaded nanoparticles. The volume of the anti-TSH antibody gating reaction was kept below 200 μl. The buffer was supplemented with 0.2 mg/ml ( 1/10 of original dye concentration in the cargo loading buffer) of the reporter dye to create an equilibrium and minimize release of cargo during the capping of silica particles. The anti-TSH antibody gating/capping continued for 10-16 hours at 4-10° C. on a tube rotator, in the dark.

Unbound anti-TSH antibody or the control antibody anti-Myo7a was removed by washing the MSN with 500 μl of PBS gentle centrifugation (400 g for 3 minutes). This step was repeated once, and the prepared antibody gated silica particles were resuspended in 100 μl PBS per mg of MSN. The preparation was kept in cold (4-10° C.) until use.

Anti-TSH antibody gated MSN (MCM-41 or SBA-15) containing reporter dyes methylene blue (1 mM stock) or Safranin-O (2 mg/ml stock).

Target triggered release of cargo dyes was first tested in “in solution” assays: 20 μl of antibody capped MSN was transferred into the wells polycarbonate microtiter plates (96 well). Onto each well, 5 μl of PBS containing 40 mIU/lt TSH antigen (in PBS pH=7.6, supplemented with the surfactant Tween 20 to a final concentration of 0.2%), was gently mixed and incubated at 37° C. on an orbital shaker (˜60 rpm) for one hour. After the incubation, the plates were allowed to sit on a bench surface for 5 minutes and the nanoparticles allowed to settle on the bottom of the well. A 5 μl aliquot of the solution was carefully removed with a multichannel automatic pipet and spotted onto a nitrocellulose paper (˜9×6 cm, WHATMAN® Protran BA83) laid over a thick cellulose blotting paper. After spotting equal amounts of reaction samples from all reactions on to the nitrocellulose, the blots were allowed to dry briefly, for approximately 3 minutes. Experiments using methylene blue as the reporter molecule were assessed visually; results are presented in FIG. 5.

For experiments using Safranin-O, photographic pictures were taken, and images digitally analyzed by image densitometry. The signal intensities as a function of release from nanoparticles were calculated with Image J (NIH, Public domain software). The image of each spot was digitally isolated from the background, signals converted to grey scale, and pixel densities recorded for quantitative evaluation. Bar graphs were generated for visualization of data. Results are shown in FIG. 4.

### Example 2—Preparation of Microfluidic Assay Cards—Acrylamide

A 3% polyacrylamide loading/immobilization gel (Sigma-Aldrich) was prepared in PBS with 0.02% Tween 20. For each reaction, an aliquot of 1 mg anti-TSH antibody gated, methylene blue dye loaded MSN was added to 100 μl of 3% polyacrylamide solution. The mixture was then deposited onto the proximal end of the detection chamber of assay cards having the configuration as shown in FIG. 1A and allowed to polymerize.

After polymerization was complete, circles (3 mm in diameter) of nitrocellulose membrane (WHATMAN® Protran, BA83 nitrocellulose membrane, 0.45 um pore size) were cut with a disposable sterile biopsy punch to create signal concentration pads. Pads were carefully placed on the assay cards at the distal end of the detection chamber. The microfluidic channels and chambers were then sealed by applying a laminated top layer on the card with openings allowing access to the sample input chamber and the detection chamber.

In some cases, cards were kept in a humidified plastic box at 4° C. until use. In other cases, cards were stored at room temperature without supplemental humidification.

### Example 3—Preparation of Microfluidic Assay Cards—Agarose

A loading/immobilization gel was prepared from 0.65% NuSieve GTG low melting temperature agarose (Lonza, 50080) in PBS supplemented with 0.3% Tween 20. After heating and agarose polymerization, the gel was brought to and kept at ˜40° C. using a water bath or a heating block.

An aliquot, consisting of 2 mg of anti-TSH antibody gated MSN, was resuspended in 23 μl of PBS solution per mg particles. Using a wide bore plastic automatic pipette tip, MSN slurry was gently mixed with the immobilization gel to a final concentration of ˜0.15%. A 7 μl aliquot of the mixture was immediately spotted onto the reaction chamber of assay cards having the configuration shown in FIG. 1B. Cards loaded with MSN were allowed to sit at room temperature for 15 minutes to facilitate further polymerization.

Circles (3 mm in diameter) of nitrocellulose membrane (WHATMAN® Protran, BA83 nitrocellulose membrane, 0.45 um pore size) were cut with a disposable sterile biopsy punch to create signal concentration pads. Pads were carefully placed on the assay cards at the distal end of the detection chamber. The microfluidic channels and chambers were then sealed by applying a laminated top layer on the card with openings allowing access to the sample input chamber and the detection chamber.

In some cases, cards were kept in a humidified plastic box at 4° C. until use. In other cases, cards were stored at room temperature without supplemental humidification.

### Example 4—Identification of TSH Concentration within a Liquid Sample

An assay card as prepared in Example 2 containing anti-TSH antibody-gated MSN was allowed to warm to room temperature for 5 minutes prior to loading test and control samples. The cards were kept horizontal on a leveled surface during the assay.

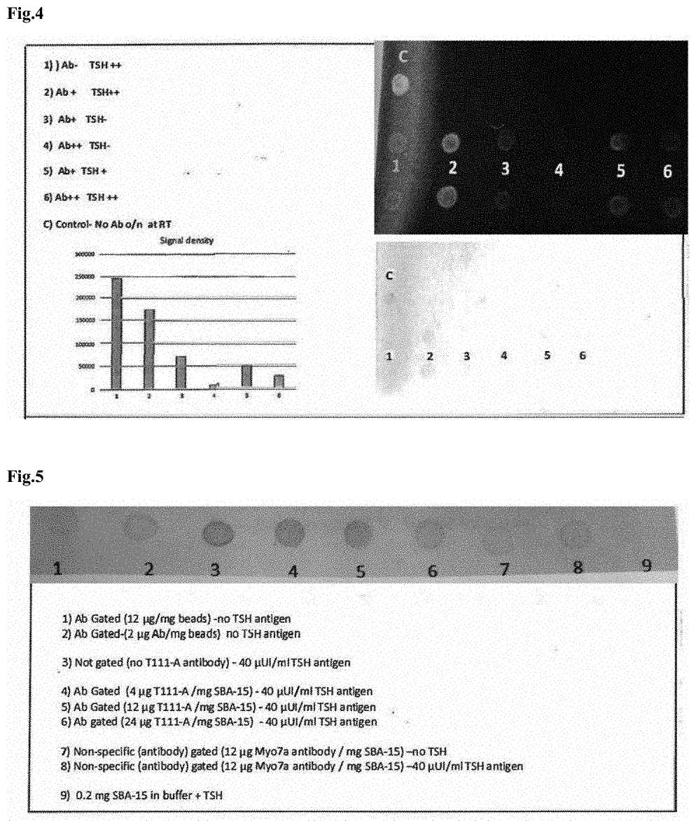

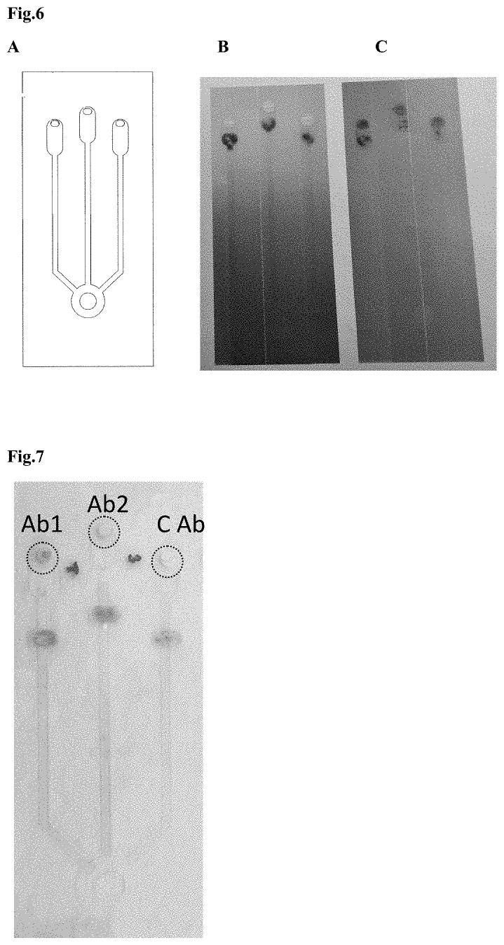

Sample dilution/reaction buffer was prepared by mixing PBS and 0.02% Tween 20 to a total volume of ˜120 μl. Test and control samples containing TSH antigen (Scripps Laboratories, ≥95% by SDS-PAGE; ≤0.1% hFSH, hGH, hLH, hPRL activity: ≥6.2 IU/mg) at various concentrations were mixed with the buffer and the resulting solution introduced to the sample input chamber on the assay card with a pipette. The prepared sample solution was allowed to flow through the channels and reach the detection chamber. After 60 minutes at room temperature, released dyes accumulated and concentrated on the signal concentration pads. The results are presented in FIG. 6.

The signal concentration pads are photographed using a cell phone camera and saved as a jpeg file for processing with image processing software Image J (available via the internet). The image of the signal pads is digitally isolated from the background, signal converted to grey scale, and pixel densities recorded for quantitative evaluation.

### Example 5—Preparation of Dye Loaded Anti-Thyroxine (T4) and Anti-Thyroid Stimulation Hormone (TSH) Antibody Gated Nanoparticles

### Preparation of Mesoporous Silica Nanoparticles

10 mg of MCM-41 nanoparticles in 1 ml pure water (Millipore, 18 mΩ) were washed for 5 minutes at room temperature with gentle agitation (approximately 80 rpm). The nanoparticles were then pelleted by brief centrifugation (14,000-18,000 rpm for 1 minute) and the supernant removed. Nanoparticles were resuspended in 1 ml of 2 mM glacial acetic acid, mixed briefly by inversion and then incubated at room temperature for 5 minutes with gentle agitation as noted above. Nanoparticles were again pelleted as before, supernatant removed, and nanoparticles resuspended in 950 μl of 2 mM glacial acetic acid, the exception being those nanoparticles destined for use with Fluorescein dye which were treated at pH4 in 1 mM acetic acid instead of 2 mM acetic acid.

Four different dyes were used: Safranin-O (2 mg/ml stock), Neutral Red (2 μg/μl stock), Eriochrome Black T (2 μg/μl stock), and Fluorescein (240 μM stock). Four separate reactions were prepared by adding 50 μl of dye to the 950 μl resuspended nanoparticles and the resulting solution was vortexed to mix. Nanoparticle solutions were incubated at room temperature with gentle agitation (approximately 65 rpm). The nanoparticle solution was then de-gassed for 3-4 minutes using a vacuum desiccator and allowed to sit for approximately 10 minutes before the vacuum seal was broken. Nanoparticles were then incubated at room temperature with nutrating agitation (2-30 rpm). After approximately 4 hours, nanoparticles were pelleted for 1 minute at 6,000 rpm (8160 g) to a maximum speed of 14,000 rpm (16,000 g) and the supernant removed. Nanoparticles were rinsed with water by inverting by and prior to pelleting again for 1 minute and removing supernatant.

A 50% solution of PEI was added to the dye loaded nanoparticles to a final concentration of 1.5-6 mg PEI/mg dye loaded nanoparticles. The nanoparticle solution was then incubated for about 20 minutes with nutating agitation (2-30 rpm). At the end of the incubation period, nanoparticles were allowed to settle out from the supernatant by gravity (i.e no centrifugation was conducted). Supernatant was removed and the pellets washed with 500 μl of 1×PBS buffer with nutrating agitation for several minutes. Nanoparticle separation was again conducted at room temperature by gravity prior to removal of the supernatant.

500 μl of 1×PBS was added to 100 μl of dye-loaded, prepared nanoparticles along with extra dye in the ratio of 1:1000 (extra dye:PBS+dye-loaded particles). 2-24 μg of antibody was added from stock solutions having a concentration of 1 μg/μl in 1×PBS the solution gently mixed by hand inverting and then incubated overnight at 7-9° C. with nutating agitation. Nanoparticles were then semi-pelleted with a one time 2-3 second pulse centrifugation prior to gravity pelleting at room temperature. Supernatant was removed and the nanoparticles washed twice, each time by a 3 minute nutating agitation at room temperature with 250 μl of 1×PBS. Nanoparticles were resuspended in 100 μl 1×PBS and mixed gently by hand inverting.

### Antigen Binding and Spotting for Test Results

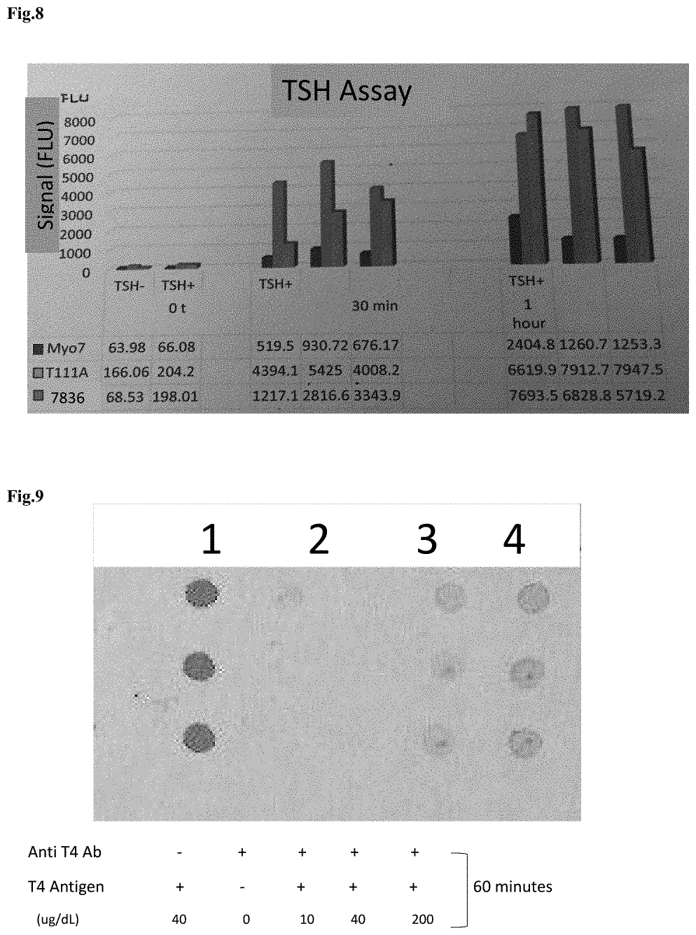

50 μl of prepared nanoparticles were placed into the wells of a 96-well microplate. 40 mIU/lt of T4 antigen in 1×PBS was added and incubated 1 hour at room temperature with gentle agitation. For experiments using Fluorescein dye, the solution assay results were read directly with a Qubit fluorometer (Thermo Fisher, California) according to manufacturer's instructions. Results are presented in FIG. 8.

For all other solution assays, 5 μl was pipetted onto BA 85 paper and visually assessed. Results are shown in FIG. 9.

We claim:

1. A system for identification and quantitation of a targeted solution analyte comprising:
a.) an assay card comprising:
i.) a sample input chamber;
ii.) at least two microchannels;
iii.) a detection or signal chamber;
iv.) at least one porous nanoparticle;
v.) at least one reporter molecule associated with the porous nanoparticle;
vi.) at least one gating molecule located on the surface of the porous nanoparticle that is a ligand specific for the targeted analyte; and
vii.) optionally at least one surface modifier molecule;
b.) an optional device cartridge comprising:
i.) a housing;
ii.) an interior chamber;
iii.) a sample input port in connection with the interior chamber; and
iv.) at least two detection windows in connection with the interior chamber;
c.) an optional reagent container comprising:
i.) a housing;
ii.) an interior chamber;
iii.) a reagent container outlet port connection with the interior chamber; and
iv.) an optional reagent container inlet port in connection with the interior chamber; and
d.) optionally software for identification and/or quantitation of signal produced from the at least one reporter molecule.

2. The system according to claim 1, wherein the assay card further comprises a reaction chamber.

3. The system according to claim 1, wherein the porous nanoparticle is located within the detection chamber and/or the reaction chamber.

4. The system according to claim 1, wherein the microchannels are essentially free of nanoparticles and/or reagents.

5. The system according to claim 1, wherein the detection or signal chamber further comprises a signal concentration pad.

6. The system according to claim 1, wherein the sample input port and the at least two detection windows of the optional device cartridge mirrors the placement of the sample input chamber and the at least two detection chambers of the assay card.

7. The system according to claim 1, wherein the optional reagent container can directly connect with the optional device cartridge.

8. The system according to claim 1, where the optional reagent container connects with the optional device cartridge via a connector.

9. The system according to claim 1, wherein the porous nanoparticles are MCM-41 and/or SBA-15 nanoparticles.

10. The system according to claim 1, wherein the gating molecule is selected from the group consisting of an antibody, a peptide, a protein, a hapten, an aptamer, a nucleic acid, and a polysaccharide, or combinations thereof.

11. The system according to claim 1, wherein the cargo molecule is selected from the group consisting of fluorescent proteins, fluorescent dyes, visual dyes, metal-based pigments, inorganic pigments, organic pigments and biological pigments, or combinations thereof.

12. The system according to claim 1, wherein the cargo molecule is a visual dye selected from the group consisting of Safranin-O, remazol red, remazol turquoise, bromocresol green, and methylene blue, or combinations thereof.

13. A method of identifying and/or quantitating a target solution analyte comprising
a.) obtaining a solution sample;
b.) applying the solution sample to the system according to claim 1 which contains a ligand specific for the target analyte;
c.) capturing an image of the detection chamber and/or the signal concentration pad; and
d.) applying the software to identify the presence of and/or quantitate the target analyte.

14. The method of claim 13, wherein the solution sample is from an environmental source.

15. The method of claim 13, wherein the solution sample is from a biological source.

16. The method of claim 15, wherein the biological source is mammalian.

17. The method of claim 15, wherein the biological source is human.

18. The method of claim 15, wherein the biological source is selected from the group consisting of blood, mucus, lymphatic fluid, synovial fluid, cerebrospinal fluid, saliva, sweat, bronchoalveolar lavage, amniotic fluid, amniotic cord blood, urine, vaginal fluid, and semen, or combinations thereof.

19. The method of claim 15, wherein the biological source is blood, plasma, urine, sweat, or combinations thereof.

20. The method of claim 13, wherein the analyte is a pollutant, a hormone, a drug, a metabolite, a cell, or combinations thereof.
